(19) United States
(12) Patent Application Publication
(10) Pub. No.: US 2003/0230382 A1
(43) Pub. Date: Dec. 18, 2003

(54) Method for releasing laminated materials

(75) Inventors: Paul John Zuraw, Mount Pleasant, SC (US); Kerry Elizabeth Robinson, Meggett, SC (US); Robert Charles Streisel, Mount Pleasant, SC (US); Ronald Duane Allen JR., Charleston, SC (US); Francis Peter Lowry, Mount Pleasant, SC (US)

Correspondence Address: MEADWESTVACO CORPORATION, 5255 VIRGINIA AVENUE, P.O. BOX 118005, CHARLESTON, SC, 29423-8005, US

(73) Assignees: Westvaco Corporation, Stamford, CT; a corporation of the state of Delaware

(21) Appl. No.: 09/992,902

(22) Filed: Nov. 14, 2001

(51) Int. Cl. B32B 33/00

(52) U.S. Cl. 156/289

(57) ABSTRACT

This invention relates to an improvement in the art of making high pressure laminated materials utilizing kraft paper. More particularly, the invention relates to an improved method of releasing from one another in a press pack a plurality of heat and pressure consolidated resin impregnated laminates, which method comprises utilizing, as a release sheet, a cellulosic-based paper substrate to which an aqueous solution of water-soluble multivalent salt (or salts) is applied during formation of the substrate, and wherein the substrate is subsequently coated after formation on at least one side salt-treated side with a film of a salt of alginic acid.

### FIELD OF INVENTION

This invention relates to an improvement in the art of making high pressure laminated materials utilizing kraft paper. More particularly, the invention relates to an improved method of releasing from one another in a press pack a plurality of heat and pressure consolidated resin impregnated laminates, which method comprises utilizing, as a release sheet, a cellulosic-based paper substrate to which an aqueous solution of water-soluble multivalent salt (or salts) is applied during formation of the substrate, and wherein the substrate is subsequently coated after formation on at least one side salt-treated side with a film of a salt of alginic acid.

### BACKGROUND OF THE INVENTION

High-pressure laminates are laminated articles typically made of a plurality of core sheets, a decorative sheet and, where desired, an overlay sheet. The sheets are treated with lamination polymers that are typically thermosetting materials, such as melamine or phenolic resins.

The core sheets are typically made from resin saturable paper (also known as saturating kraft paper). The number of core sheets used depends on the application requirements (e.g., strength and environment) and the desired thickness of the laminate. Laminates normally have a thickness ranging from 0.02 to 0.09 inch. The core sheets are typically saturated with phenolic resins.

The decorative sheets are commonly made of paper comprised of cellulose fibers and may contain an opacifying pigment (such as titanium oxide). While decorative sheets are usually printed upon with designs to create a decorative pattern for the laminate, the sheets may be left plain for industrial purposes. The decorative sheets are typically saturated with melamine resins.

The overlay sheets are clear cellulose sheets that act as a protective layer over the decorative sheet. These sheets are usually saturated with melamine resins. The overlay sheets are used optionally depending on the need for protective surfaces.

In a typical process for preparing laminates, the sheets are saturated with the appropriate thermoset resins and then stacked. The stacked sheet assembly is subsequently placed in a press and consolidated under heat and pressure. During this operation the resin flows sufficiently to displace air between the sheets. Simultaneously the resin polymerizes into a rigid solid, thereby producing a monolithic structure as the finished laminate composite.

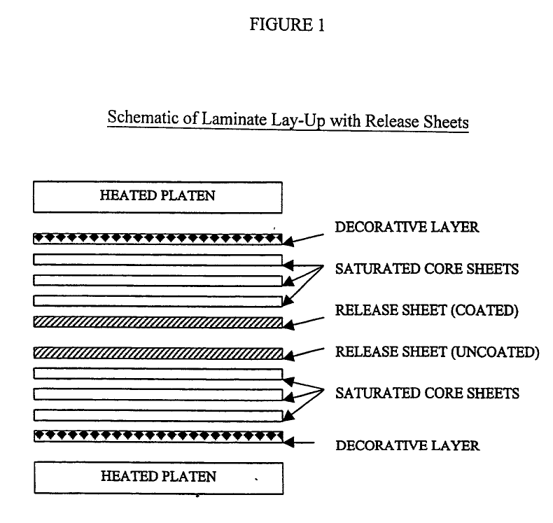

It is economically desirable to produce a number of laminate panels from one pressing operation by placing a plurality of sheet assemblies in the press at the same time. FIG. 1 below shows the layering of two sheet assemblies that are divided by release sheets. Release sheets are placed between the core layers of the two sheet assemblies to facilitate the separation of the two laminate panels by preventing the respective core layers from fusing together.

Traditionally, a sheet of glassine that has been treated on one side with a release compound (such as silicone, chromium complexes, and the like) is employed as a release sheet. After curing in the press, this sheet separates from the assembly adjacent to its treated surface and remains adhered to the other assembly. However, major problems exist with the utilization of such treated glassine papers as release sheets, in that the release compound interferes with glue adhesion-thereby requiring that the laminate be deep sanded to completely remove the glassine paper from the surface of the laminate. Moreover, the required sanding often causes the release of chromium and other complexes, thereby raising environmental concerns.

Several attempts have been made to produce commercially effective high-pressure laminate release sheets. In U.S. Pat. No. 3,050,434, Emily Jr. et al. discloses a kraft paper core sheet impregnated with phenolic resin and coated with an alginic acid salt (such as sodium alginate) for use as a release sheet. However, it was found the alginate salt was mostly absorbed by the paper, thereby creating release problems. In U.S. Pat. No. 3,215,579, Hagen claims the use of release sheets wherein a web of paper is sized with an aqueous solution of water-soluble alkaline earth or alkaline earth metal salts, then coated with an alginic acid salt film. However, it was found that absorption by the sized release sheet of the sizing agent and alginic salt coating often created release problems. Ward, in U.S. Pat. No. 3,898,114, teaches release coatings comprising poly(vinyl alcohol) and methyl cellulose. In U.S. Pat. No. 4,263,073, Jaisle et al. teaches the use of separator sheets comprising a web of phenol-formaldehyde resin-free paper having a water absorption of at least about 200 seconds sized first with a water-soluble salt of an earth metal or alkaline earth metal, then sized with a salt of alginic acid. Jaisle et al. further teaches, in U.S. Pat. No. 4,243,461 the use of separator sheets comprising a web of phenol-formaldehyde resin-free paper having a water absorption of at least about 200 seconds sized first with a water-soluble salt of an earth metal or alkaline earth metal, then sized with a mixture of triglyceride, lecithin, or hydrolyzed lecithin and a salt of alginic acid. However, the use of these types of paper is relatively expensive. Gray, in U.S. Pat. No. 4,327,121, teaches the use of electron beam radiation to polymerize certain acrylic functional materials as coatings for release sheets. In U.S. Pat. No. 4,510,199, Brooker teaches release sheets comprising a thermosetting resin impregnated fibrous core sheet coated with a mixture of wax and alginate salt. The use of release sheets coated with a mixture of a silicone-acrylate release component, an acrylate-containing cross-linking agent, and an acrylic ester monomer or oligomer are taught by Lu in U.S. Pat. No. 5,425,991. However, a need exists in the industry for a release sheet with improved characteristics that can be economically produced for use with high-pressure laminated materials.

Therefore, an object of this invention is to disclose an improved method of releasing high pressure laminated materials.

Another object of the present invention is to produce laminates by an improved method that results in savings in production costs as compared to conventional methods.

Other objects, features, and advantages of the invention will be apparent from the details of the invention as more fully described and claimed.

### SUMMARY OF THE INVENTION

These and other objects of the invention, as embodied and broadly described herein, are met by an improved method of releasing from one another in a press pack a plurality of heat and pressure consolidated resin impregnated laminates, wherein said method comprises utilizing, as a release sheet, a cellulosic-based paper substrate to which an aqueous solution of a multivalent salt (or salts) is applied to at least one surface of the substrate during formation of the substrate. After formation, the substrate is subsequently coated on at least one salt-treated side with a film of a salt of alginic acid, and then employed as a release sheet in laminate production.

As noted above, U.S. Pat. No. 3,215,579 to Hagen claims the use of release sheets wherein a web of paper is sized with an aqueous solution of water-soluble alkaline earth or alkaline earth metal salts, then coated with an alginic acid salt film. However, there were number of problems associated with the method taught by Hagen. Indeed, commonly assigned U.S. Pat. Nos. 4,263,073 and 4,243,461 to Jaisle et al. both note (col. 2, lines 38-57) that the sized release sheet taught by Hagen absorbed a great deal of sizing agent and alginic salt. This excessive absorption frequently resulted in inferior release when used to separate decorative laminates undergoing consolidation. Large amounts of alginic salt, even when applied in sequential layers, did not improve these deficiencies. It was only by incorporating a phenolic resin that Hagen was able to produce a satisfactory release sheet. However, the use of such a resin, before sizing, is very costly.

What Hagen teaches to skilled artisan is the production of a release sheet, wherein a paper sheet is first formed, then subsequently post-treated in a separate sizing operation with an aqueous solution of water-soluble alkaline earth or alkaline earth metal salts, and finally coated with an alginic acid salt film. The method of the present invention improves upon the process taught by Hagen by eliminating the expensive post-treatment sizing operation. In the present method, an aqueous solution of multivalent salt (or salts) is applied to at least one surface of a cellulosic-based paper substrate during formation of the substrate (i.e., “on-machine”). The substrate is then coated on at least one salt-treated side with a film of a salt of alginic acid and employed as a release sheet in laminate production.

The salts employed in the present method exhibit a multivalent ionic charge. The multivalent charge permits the salt ions to displace ions attached to the acid groups on the alginate so that the salt cross-links the alginate polymer. This action increases the viscosity of the coating, thereby inhibiting the polymer's penetration of the sheet. This improves the holdout of the release coating, which provides better release performance.

Prior to the present invention, it was believed that the application of salts on-machine to a cellulosic-based paper substrate (such as saturating kraft paper and the like) was not feasible due to absorption problems and other potential adverse effects to both the substrate and the paper machine. It was, therefore, unexpected that such salts could be applied on-machine during formation of cellulosic-based paper substrate in such a manner as to ensure that the substrate retained a sufficient amount of salt on it's surface to permit effective cross-linking of the alginate. Moreover, it has been found that a relatively small application of salts on-machine is effective, as the evaporation of liquid from the surface of the substrate and other conditions act to slow absorption by the substrate of the salt solution.

### DESCRIPTION OF THE DRAWING

For a better understanding of the invention, reference may be made to the preferred embodiment exemplary of the invention, shown in the accompanying drawing. FIG. 1 illustrates a laminate stack-up set wherein only one salt-treated release sheet is coated with the film of a salt of alginic acid. Resin from the treated core stock penetrates the dry paper of the release sheet. After pressing, the release sheet facilitates separation of the laminates (and the release sheets will be part of the decorative laminate).

### DESCRIPTION OF THE PREFERRED EMBODIMENT

The invention is a method of releasing laminates from one another in a heat and pressure consolidated press pack which comprises:

a) arranging a plurality of thermosetting synthetic resin-impregnated fibrous core sheets in superimposed relationship in groups of at least two stacks,

b) separating said stacks from one another with a release sheet comprising a cellulosic-based paper substrate, wherein the improvement comprises the salt-treatment of at least one surface of said substrate during formation of the substrate via the application to said surface of an aqueous solution comprising at least one multivalent salt in an amount sufficient to provide a solids content of about 0.01% to about 3.0% by weight based upon the dry weight of the substrate, and wherein said substrate is coated after formation on at least one salt-treated surface with a film comprising at least one salt of alginic acid,

c) consolidating said stacks of core sheets by the application of heat and pressure thereto, and

d) separating the resulting laminates from one another at the locus of said release sheet.

A wide variety of cellulosic-based paper substrates may be employed in the present invention. In fact, any cellulosic-based paper substrate that is suitable for use in producing heat and pressure consolidated laminates may be used. It is preferred that the substrate be saturating paper. It is also preferred that the substrate be phenol-formaldehyde resin-free paper.

Multivalent salts suitable for use in the present invention include those derived from aluminum, barium, beryllium, calcium, chromium, copper, iron, magnesium, strontium, zinc, zirconium, and the like. A wide variety of multivalent salts may be employed. In fact, any multivalent salt or mixture of multivalent salts which is sufficiently soluble in water to provide a solution which, in turn, will be sufficiently concentrated to permit coating of the cellulosic-based paper substrate during formation with the necessary amount of multivalent can be used. It is preferred that the multivalent salt be one that is relatively non-corrosive to metals commonly employed in paper machines (such as cast iron, stainless, steel, aluminum, etc.). It is also preferred that the multivalent salt be a salt derived from aluminum, calcium, magnesium, or zirconium. It is further preferred that the salt be calcium propionate.

In the current method the multivalent salt is dissolved in water to form an aqueous solution. The desired salt concentration of the solution may vary depending on the location and method of application to the cellulosic-based paper substrate. It is preferred that the aqueous salt solution be applied to the substrate after formation of the dry line on the Fourdrinier. It is further preferred that the solution be applied after the substrate web has been partially dried.

Suitable methods for applying the multivalent salt solution to the surface of the substrate include using showers, size presses, and water boxes. For paper manufactured utilizing a traditional Fourdrinier papermaking process it is preferred to apply the salt solution only to the bottom (or wire) surface of the paper. However, the salt solution may be applied to both surfaces of the paper if desired. Size presses or water boxes may be utilized if the salt is to be applied during the paper's drying cycle. The preferred method of application is to use a shower or series of showers after the paper sheet is formed. It is further preferred to apply the salt via a fine spray or misting shower before the sheet is completely dried. Each application method lightly covers the saturating kraft with the salt solution.

The multivalent salt solution is applied during the production of the substrate in an amount sufficient to provide a solids content of about 0.01% to about 3.0% by weight, based upon the dry weight of the substrate. It is preferred that the salt be applied in an amount sufficient to provide a solids content in the range of about 0.05% to about 1.0% by weight, based upon the dry weight of the substrate, with the most preferred solids content being in the range of about 0.1% to about 0.5%.

In applying the multivalent salt to the paper a suitable application rate for the salt is in the range of about 0.02 to about 4.8 pounds of dry salt per 3,000 square feet of saturating kraft produced. Where the saturated kraft has a basis weight of 156 lb./3,000 ft.², the above-noted salt application rate is equivalent to a range of about 0.2 to about 60.0 pounds of dry salt per ton of paper produced. (Of course, the salt application rate when measured in pounds of dry salt per ton of saturated kraft produced will vary according to the type of salt used and the basis weight of the paper.) The preferred application rate is about 0.16 to about 0.8 lb./3,000 ft.² or about 2 to about 10 lb./ton. It is well within the ability of a skilled artisan to calculate the application rate and salt solution concentration necessary to apply a desired amount of salt to the cellulosic-based paper substrate via a particular method of application.

After formation, the salt-coated cellulosic-based paper substrate is coated with a film of an aqueous solution containing at least one salt of alginic acid. The alginic acid salt film may be applied to the substrate in any manner known in the art that results in a uniform covering of the substrate by the alginic acid salt film. Suitable application methods include the use of blades, air knifes, rod coaters, dipping, spraying, reverse roll coating, and the like. The alginic acid salt film may be applied to either or both sides of release sheet, so long as the film is applied to at least one side of the sheet to which alkaline earth metal salt and/or earth metal salt had been applied during formation of the sheet.

The wet alginate salt film is applied at a thickness level of at least about 0.0005 inch, with the more preferable thickness being at least about 0.001 inch. No upper limit on the thickness of the wet alginate need be observed, although a wet film of more than about 0.01 inch thickness is generally unnecessary.

Alginic acid salts which are suitable for use in the present invention include, but are not limited to, the following: ammonium alginate, iron alginate, lithium alginate, potassium alginate, sodium alginate, and combinations thereof. Such alginates are commercially available and come in a plurality of forms, with most aqueous solutions having viscosities that vary significantly with the concentration of alginate solids therein. In practicing the current invention, about 1.0% to about 15.0% aqueous alginate salt solutions having viscosities ranging from about 5 centipoises to about 1,000 centipoises at 25° C. are especially suitable. The use of sodium alginate is preferred.

Where desired, additional components may be added to the aqueous alginic acid salt solution. Examples of such components included waxes, oils, lubricants, fillers, release-agents, and preservatives.

After being coated with the alginate salt film, the substrate is dried to a desired moisture content (e.g., a moisture content of less than about 8% by weight of the dried substrate). The substrate is then ready for use as a release sheet.

Where the release sheet, whether impregnated or unimpregnated with a thermosetting synthetic resin, is coated on one side only with the alginate salt film, it will become an integral part of one of the laminates that it separates. On the other hand, where the release sheet has been salt-treated on both sides during formation and is subsequently coated on both sides with alginate salt film, it can be removed from between the finished laminates.

If desired, a pair of sheets coated on one side only with the alginate salt film rather than a single sheet can be used in separating laminating assemblies and releasing the individual laminates. In using such a pair of sheets, their alginate-coated sides will be positioned face-to-face in direct contact with one another. Thus, upon separation of the pair of laminates, the respective release sheets will remain an integral part of the laminates to which they adhere on their uncoated sides.

The following examples are provided to further illustrate the present method and are not to be construed as limiting the invention in any manner.

### EXAMPLE 1

A spray application of an aqueous 5.6% solids solution (based on dry weight) of calcium propionate was applied on a Beloit Paper Machine producing 115 lb./3,000 ft.² saturating kraft paper. The calcium propionate solution was applied to the wire side of the paper judo sheet at the breaker stack using two spray manifolds containing a total of 78 air atomization nozzle heads at a rate of about 3.5 gallons per hour per nozzle. The manifolds were staggered to allow for optimum coverage of the paper across the web. The salt application was calculated to be approximately 0.20 lb./3,000 ft.² or 3.59 lb./ton of paper.

For evaluation purposes, the salt-treated paper was subsequently coated with one of three commercially available sodium alginate formulations (SCOGIN™HV, SCOGIN™MV, or SCOGIN™LV from Pronova Biopolymer). Solutions of each type of sodium alginate were applied at a solids content level of 0.5% or 1.0% to the salt-treated side of the paper using an 80-mil wire wrapped bar. The viscosities of the various solutions (as provided by Pronova Biopolymer) are shown in Table I below. The sheets were restrained and dried in a forced air oven set at 125° C. for approximately 30 minutes. The release sheets were then conditioned for at least two hours at 72° F. and 50% relative humidity prior to analysis. For evaluation purposes, control release sheets were also produced wherein 115 lb./3,000 ft.² saturating kraft paper which had not been salt-treated was coated using the same sodium alginate coating formulations. The glosses of the respective sheets were subsequently measured using a Pro Gloss Meter (from Hunter Lab).

Two laminate sandwiches (12″×12″) consisting of a decorative sheet and three 140 lb./3,000 ft.² saturating kraft treated with a phenolic resin were pressed back to back. The coated release paper to be tested and the corresponding control paper separated the laminates. The release papers were cut larger than the laminate to prevent sticking from resin flow at the laminate edges. The laminates were pressed at 1,200 psi while heating to 225° F. over 23 minutes and then to 285° F. over 17 minutes. The laminates were cooled prior to opening the press. Aluminum foil separated the decorative layer from the caul plates. The laminates were separated by hand and evaluated. The evaluation results are contained in Table II below.

TABLE I
Viscosities of Sodium Alginate Coating Formulations

Brookfield Viscosity (LVF Viscometer,
60 cpm, 25° C.)

| Product | 0.5% Solution (cps) | 1.0% Solution (cps) |
|---|---|---|
| SCOGIN ™HV | 130 | 800 |
| SCOGIN ™HV | 80 | 400 |
| SCOGIN ™HV | 20 | 60 |

TABLE II
Gloss and Release Properties of 115 lb./3,000 ft.² Saturating Paper
Modified with Calcium Propionate and Coated with Sodium Alginate

| | | | | |
|---|---|---|---|---|
| Solids | Type of | | | |
| of Sodium | Sodium | Sodium Alginate | 60° | Release |
| Alginate (%) | Alginate^{(a)} | Level (lb./1,000 ft²) | Gloss^{(b)} | Rating^{(c)} |

Control-Standard Paper

| | | | | |
|---|---|---|---|---|
| 1.0 | HV | 0.32 | 5.3 | 3.5 |
| 1.0 | MV | 0.32 | 4.8 | 3.0 |
| 1.0 | LV | 0.31 | 4.4 | 2.0 |
| 0.5 | HV | 0.16 | 4.6 | 3.0 |
| 0.5 | MV | 0.16 | 4.3 | 1.0 |
| 0.5 | LV | 0.16 | 3.7 | 1.0 |

Calcium-Modified Paper

| | | | | |
|---|---|---|---|---|
| 1.0 | HV | 0.27 | 6.6 | 4.0 |
| 1.0 | MV | 0.29 | 6.3 | 4.0 |
| 1.0 | LV | 0.29 | 6.4 | 4.0 |
| 0.5 | HV | 0.15 | 5.6 | 3.5 |
| 0.5 | MV | 0.15 | 5.0 | 3.0 |
| 0.5 | LV | 0.16 | 4.8 | 3.0 |

^{(a)}HV = SCOGIN ™HV, MV = SCOGIN ™MV, LV = SCOGIN ™HV (available from Pronova Biopolymer).
^{(b)}Measured using a Pro Gloss Meter (commercially available from Hunter Lab).
^{(c)}Release is qualitatively rated from 0 (no release) to 5 (excellent).

The change in gloss between the calcium-modified and unmodified paper can be used as an indication that sufficient calcium propionate was applied to affect the holdout of the sodium alginate coating. Sodium alginate is gelled by calcium from the propionate exchanging with the sodium. Gellation is due to the crosslinking of the alginate, which affects holdout and, therefore, the gloss of the paper.

As shown above, gloss decreased with application of lower levels of release coating. At each alginate coat weight, the gloss on the standard paper was lower than the calcium salt-modified paper. Likewise, the salt-modified release paper exhibited superior release properties when compared to the control release paper.

### EXAMPLE 2

A spray application of an aqueous 5.6% solids solution (based on dry weight) of calcium propionate was applied on a Beloit Paper Machine producing 184 lb./3,000 ft.² saturating kraft paper. The calcium propionate solution was applied to the wire side of the paper sheet at the calender using two spray manifolds containing a total of 78 air atomization nozzle heads at a rate of about 3.5 gallons per hour per nozzle. The manifolds were staggered to allow for optimum coverage of the paper across the web. The salt application was calculated to be approximately 0.31 lb./3,000 ft.² or 3.52 lb./ton of paper.

For evaluation purposes, the salt-treated paper was subsequently coated with one of three commercially available sodium alginate formulations (SCOGIN™HV, SCOGIN™MV, or SCOGIN™LV from Pronova Biopolymer). Solutions of each type of sodium alginate were applied at a solids content level of 0.5% or 1.0% to the salt-treated side of the paper using a 80-ml. wire wrapped bar. The viscosities of the various solutions are shown in Table I above. The sheets were restrained and dried in a forced air oven set at 125° C. for approximately 30 minutes. The release sheets were then conditioned for at least two hours at 72° F. and 50% relative humidity prior to analysis. For evaluation purposes, control release sheets were also produced wherein 115 lb./3,000 ft.² saturating kraft paper which had not been salt-treated was coated using the same sodium alginate coating formulations. The glosses of the respective sheets were subsequently measured using a Pro Gloss Meter (from Hunter Lab).

Two laminate sandwiches (12″×12″) consisting of a decorative sheet and three 140 lb./1,000 ft.² saturating kraft treated with a phenolic resin were pressed back to back. The coated release paper to be tested and the corresponding control paper separated the laminates. The release papers were cut larger than the laminate to prevent sticking from resin flow at the laminate edges. The laminates were pressed at 1,200 psi while heating to 225° F. over 23 minutes and then to 285° F. over 17 minutes. The laminates were cooled prior to opening the press. Aluminum foil separated the decorative layer from the caul plates. The laminates were separated by hand and evaluated. The evaluation results are contained in Table III below.

TABLE III
Gloss and Release Properties of 184 lb./3,000 ft.² Saturating Paper
Modified with Calcium Propionate and Coated with Sodium Alginate

| | | | | |
|---|---|---|---|---|
| Solids | Type of | | | |
| of Sodium | Sodium | Sodium Alginate | 60° | Release |
| Alginate (%) | Alginate^{(a)} | Level (lb./1,000 ft²) | Gloss^{(b)} | Rating^{(c)} |

Control-Standard Paper

| | | | | |
|---|---|---|---|---|
| 1 | HV | 0.32 | 5.5 | 3.5 |
| 1 | MV | 0.31 | 5.6 | 3.0 |
| 1 | LV | 0.32 | 5.3 | 2.0 |
| 0.5 | HV | 0.17 | 4.8 | 3.0 |
| 0.5 | MV | 0.17 | 4.6 | 3.5 |
| 0.5 | LV | 0.17 | 3.5 | 3.0 |

Calcium-Modified Paper

| | | | | |
|---|---|---|---|---|
| 1 | HV | 0.33 | 6.8 | 4.5 |
| 1 | MV | 0.29 | 6.5 | 4.5 |
| 1 | LV | 0.31 | 6.8 | 4.0 |
| 0.5 | HV | 0.15 | 5.8 | 4.0 |
| 0.5 | MV | 0.16 | 5.4 | 4.0 |
| 0.5 | LV | 0.17 | 5.1 | 3.0 |

^{(a)}HV = SCOGIN ™HV, MV = SCOGIN ™MV, LV = SCOGIN ™HV (commercially available from Pronova Biopolymer).
^{(b)}Measured using a Pro Gloss Meter (commercially available from Hunter Lab).
^{(c)}Release is qualitatively rated from 0 (no release) to 5 (excellent)

### EXAMPLE 3

A spray application of an aqueous solution of 10% (based on dry weight) calcium propionate was applied on a Beloit Paper Machine producing 156 lb./3,000 ft.² saturating kraft paper. The calcium propionate solution was applied to the wire side of the paper sheet at the breaker stack using three air atomization spray heads spaced six inches apart at a rate of about six gallons per hour per nozzle. Each nozzle covered approximately six inches of the paper, and the nozzle assembly was positioned in an edge roll position of the sheet. The salt application was calculated to be approximately 0.4 lb. of calcium propionate per 3,000 ft.² of paper to provide a salt content of about 0.25%.

A sodium alginate coating formulation containing a solids content level of 1.5% was applied to the salt-treated side of the paper using a 90-mil wire wrapped bar. The target coat weight using this bar and the concentrated alginate coating was 0.5 lb./1,000 ft.² The sheets were restrained and dried in a forced air oven set at 125° C. for approximately 30 minutes. The release sheets (hereinafter “Release Sheet No. 3”) were then conditioned for at least two hours at 72° F. and 50% relative humidity prior to analysis. For evaluation purposes, control release sheets (hereinafter “Control Sheet No. 3”) were also produced wherein 156 lb./3,000 ft.² saturating kraft paper which had not been salt-treated was coated using the same sodium alginate coating formulation.

### EXAMPLE 4

A spray application of an aqueous solution of 10% (based on dry weight) calcium propionate was applied on a Beloit Paper Machine producing 156 lb./3,000 ft.² saturating kraft paper. The calcium propionate solution was applied to the wire side of the paper sheet at the calender location using three air atomization spray heads spaced six inches apart at a rate of about six gallons per hour per nozzle. Each nozzle covered approximately six inches of the paper, and the nozzle assembly was positioned in an edge roll position of the sheet. The salt application was calculated to be approximately 0.4 lb. of calcium propionate per 3,000 ft.² of paper to provide a salt content of about 0.25%.

A sodium alginate coating formulation consisting a solids content level of 1.5% was applied to the salt-treated side of the paper using a 90-mil wire wrapped bar. The target coat weight using this bar and the concentrated alginate coating was 0.5 lb./1,000 ft.². The sheets were restrained and dried in a forced air oven set at 125° C. for approximately 30 minutes. The release sheets (hereinafter “Release Sheet No. 4”) were then conditioned for at least two hours at 72° F. and 50% relative humidity prior to analysis. For evaluation purposes, control release sheets (hereinafter “Control Sheet No. 4”) were also produced wherein 156 lb./3,000 ft.² saturating kraft paper which had not been salt-treated was coated using the same sodium alginate coating formulation.

### EXAMPLE 5

A spray application of an aqueous solution of 5% (based on dry weight) calcium propionate was applied on a Beloit Paper Machine producing 156 lb./3,000 ft.² saturating kraft paper. The calcium propionate solution was applied to the wire side of the paper sheet at the breaker stack using three air atomization spray heads spaced six inches apart at a rate of about six gallons per hour per nozzle. The nozzle covered approximately six inches of the paper, and the As nozzle assembly was positioned in an edge roll position of the sheet. The salt application was calculated to be approximately 0.2 lb. of calcium propionate per 3,000 ft.² of paper to provide a salt content of about 0.125%.

A sodium alginate coating formulation containing a solids content level of 1.5% was applied to the salt-treated side of the paper using a 90-mil wire wrapped bar. The target coat weight using this bar and the concentrated alginate coating was 0.5 lb./1,000 ft.². The sheets were restrained and dried in a forced air oven set at 125° C. for approximately 30 minutes. The release sheets (hereinafter “Release Sheet No. 5”) were then conditioned for at least two hours at 72° F. and 50% relative humidity prior to analysis. For evaluation purposes, control release sheets (hereinafter “Control Sheet No. 5”) were also produced wherein 156 lb./3,000 ft.² saturating kraft paper which had not been salt-treated was coated using the same sodium alginate coating formulation.

### EXAMPLE 6

A spray application of an aqueous solution of 5% (based on dry weight) calcium propionate was applied on a Beloit Paper Machine producing 156 lb./3,000 ft.² saturating kraft paper. The calcium propionate solution was applied to the wire side of the paper sheet at the calender location using three air atomization spray heads spaced six inches apart at a rate of about six gallons per hour per nozzle. The nozzle covered approximately six inches of the paper, and the nozzle assembly was positioned in an edge roll position of the sheet. The salt application was calculated to be approximately 0.2 lb. of calcium propionate per 3,000 ft.² of paper to provide a salt content of about 0.125%.

A sodium alginate coating formulation containing a solids content level of 1.5% was applied to the salt-treated side of the paper using a 90-mil wire wrapped bar. The target coat weight using this bar and the concentrated alginate coating was 0.5 lb./1,000 ft.². The sheets were restrained and dried in a forced air oven set at 125° C. for approximately 30 minutes. The release sheets (hereinafter “Release Sheet No. 6”) were then conditioned for at least two hours at 72° F. and 50% relative humidity prior to analysis. For evaluation purposes, control release sheets (hereinafter “Control Sheet No. 6”) were also produced wherein 156 lb./3,000 ft.² saturating kraft paper which had not been salt-treated was coated using the same sodium alginate coating formulation.

### EXAMPLE 7

Laminates were made for evaluation purposes from Release Sheets Nos. 3-6 and Control Sheets Nos. 3-6 via the following procedure.

Two laminate sandwiches (11.5″×8.25″) consisting of a decorative sheet and three 140 lb./3,000 ft.² saturating kraft treated with a phenolic resin were pressed back to back. The coated release paper to be tested and the corresponding control paper separated the laminates. The release papers were cut larger than the laminate to prevent sticking from resin flow at the laminate edges. The laminates were pressed at 1,200 psi while heating to 225° F. over 23 minutes and then to 285° F. over 17 minutes. The laminates were cooled prior to opening the press. Aluminum foil separated the decorative layer from the caul plates. The laminates were separated by hand and evaluated. The evaluation results are contained in Table IV below.

TABLE IV
Gloss and Release Properties of 156 lb./3,000 ft.² Saturating Paper
Modified with Calcium Propionate and Coated with Sodium Alginate

| | | | | |
|---|---|---|---|---|
| | Calcium^{(a)} | Release Coating | 60° | Release |
| Release Sheet | Propionate (%) | (lb./1,000 ft.²) | Gloss^{(b)} | Rating^{(c)} |

Application at Breaker Stack

| | | | | |
|---|---|---|---|---|
| Control No. 3 | 0.0 | 0.47 | 5.1 | 4.0 |
| Control No. 5 | 0.0 | 0.49 | 5.1 | 4.0 |
| Release No. | 0.250 | 0.46 | 7.6 | 5.0 |
| 3^{(d)} | | | | |
| Release No. | 0.125 | 0.46 | 6.7 | 5.0 |
| 5^{(d)} | | | | |

Application at Calender Stack

| | | | | |
|---|---|---|---|---|
| Control No. 4 | 0.0 | 0.49 | 5.4 | 4.0 |
| Control No. 6 | 0.0 | 0.50 | 5.3 | 4.0 |
| Release No. | 0.250 | 0.47 | 7.8 | 5.0 |
| 4^{(e)} | | | | |
| Release No. | 0.125 | 0.45 | 7.5 | 5.0 |
| 6^{(e)} | | | | |

^{(a)}The level of calcium propionate is based on the calculated dry weight of the paper.
^{(b)}Measured via Pro Gloss Meter (commercially available from Hunter Lab).
^{(c)}Release is qualitatively rated from 0 (no release) to 5 (excellent).
^{(d)}Calcium propionate solution applied at breaker stack.
^{(e)}Calcium propionate solution applied at calender stack.

As shown above, gloss decreased with application of lower levels of release coating. At each alginate coat weight, the gloss on the standard paper was lower than the calcium salt-modified paper. Paper modified with calcium propionate at the breaker stack had the highest gloss at each level of release coating. Likewise, the salt-modified release paper exhibited superior release properties when compared to the control release paper.

### EXAMPLE 8

Following the procedures in Example 3 and 4 above, a series of release sheets were produced wherein an aqueous solution of 10% (based on dry weight) of calcium propionate was applied on a Beloit Paper Machine producing 140 lb./3,000 ft.² saturating kraft paper. The resulting paper was subsequently treated with alginate release coatings ranging from 0.20-0.40 lb./1,000 ft.². The level of the release coating was reduced by lowering the solids of the formulation and applying a constant wet weight with a 90 ml. wire wrapped rod. For evaluation purposes, control release sheets were also produced wherein 140 lb./3,000 ft.² saturating kraft paper which had not been salt-treated was coated using the same alginate release coatings. Laminates were produced and evaluated using the procedure of Example 7 above. The results are shown in Table V below.

TABLE V
Gloss and Release Properties of 140 lb./3,000 ft.²
Saturating Paper Modified with 0.25% Calcium Propionate
and Coated with Sodium Alginate

| | | | |
|---|---|---|---|
| Release Coating | Release Coating | | Release |
| Solids (%)^{(a)} | (lb./1,000 ft.²⁾ | 60° Gloss^{(b)} | Rating^{(c)} |

Application at Breaker Stack

| | | | |
|---|---|---|---|
| 1.5 | 0.45 | 6.5 | 5.0 |
| 1.1 | 0.34 | 6.4 | 5.0 |
| 0.9 | 0.28 | 6.2 | 5.0 |
| 0.6 | 0.20 | 5.6 | 5.0 |

Application at Calender

| | | | |
|---|---|---|---|
| 1.5 | 0.45 | 6.0 | 5.0 |
| 1.1 | 0.34 | 5.8 | 5.0 |
| 0.9 | 0.30 | 5.5 | 5.0 |
| 0.6 | 0.20 | 5.2 | 5.0 |

Control Sheets

| | | | |
|---|---|---|---|
| 1.5 | 0.45 | 5.1 | 4.5 |
| 1.1 | 0.35 | 4.9 | 4.0 |
| 0.9 | 0.30 | 4.8 | 3.5 |
| 0.6 | 0.21 | 4.3 | 3.5 |

^{(a)}Solids content of the applied sodium alginate release coating.
^{(b)}Measured via a Pro Gloss Meter (commercially available from Hunter Lab).
^{(c)}Release is qualitatively rated from 0 (no release) to 5 (excellent).

The gloss on the control sheets was lower than that on the calcium salt-modified paper. Paper modified with calcium propionate at the breaker stack had the highest gloss at each level of release coating. Likewise, the salt-modified release paper exhibited superior release properties when compared to the control release paper.

### EXAMPLE 9

A spray application of an aqueous solution of 10% (based on dry weight) calcium propionate was applied on a Beloit Paper Machine producing a 50 inch wide roll of 184 lb./3,000 ft.² saturating kraft paper. The calcium propionate solution was applied to the wire side of the paper sheet at the calender location using eight air atomization spray heads spaced six inches apart at a rate of about six gallons per hour per nozzle. Each nozzle covered approximately six inches of the paper, and the nozzle assembly was positioned in an edge roll position of the sheet. The salt application was calculated to be approximately 0.48 pound of calcium propionate per 3,000 ft.² of paper to provide a salt content of about 0.25%.

Samples of the paper were collected and evaluated across the CD of the 50 inch wide roll. Samples from the outside edge, center, and inside edge were evaluated with different application levels of the alginate coating formulation of Example 1, wherein the coating formulation was applied at levels from 0.15-0.26 lb./1,000 ft.². For evaluation purposes, control release sheets were also produced wherein 184 lb./3,000 ft.² saturating kraft paper which had not been salt-treated was coated using the same alginate coating formulation. Laminates were produced and evaluated using the procedure of Example 7 above. The evaluation results are shown in Table VI below.

TABLE VI
Gloss and Release Properties of 184 lb./3,000 ft.²
Saturating Paper Modified at the Calender with 0.25% Calcium
Propionate and Coated with Sodium Alginate

| | | |
|---|---|---|
| Release Coating | | |
| (lb./1,000 ft.²) | 60° Gloss^{(a)} | Release Rating^{(b)} |

Control Release Sheets

| | | |
|---|---|---|
| 0.26 | 4.5 | 3.5 |
| 0.19 | 3.9 | 3.5 |
| 0.15 | 3.6 | 3.0 |

Modified Outside Edge

| | | |
|---|---|---|
| 0.26 | 4.7 | 5.0 |
| 0.19 | 4.7 | 4.5 |
| 0.15 | 4.7 | 5.0 |

Modified Center

| | | |
|---|---|---|
| 0.26 | 5.0 | 5.0 |
| 0.19 | 5.4 | 5.0 |
| 0.15 | 4.8 | 5.0 |

Modified Inside Edge

| | | |
|---|---|---|
| 0.26 | 5.0 | 5.0 |
| 0.19 | 5.0 | 5.0 |
| 0.15 | 4.8 | 4.5 |

^{(a)}Measured via a Pro Gloss Meter (commercially available from Hunter Lab).
^{(b)}Release is qualitatively rated from 0 (no release) to 5 (excellent).

The gloss on the control release sheet paper was lower than that of the calcium salt-modified paper. Likewise, the salt-modified release paper exhibited superior release properties when compared to the control release paper.

Many modifications and variations of the present invention will be apparent to one of ordinary skill in the art in light of the above teachings. It is therefore understood that the scope of the invention is not to be limited by the foregoing description, but rather is to be defined by the claims appended hereto.

What is claimed is:

1. An improved method of releasing laminates from one another in a heat and pressure consolidated press pack which comprises:
a) arranging a plurality of thermosetting synthetic resin-impregnated fibrous core sheets in superimposed relationship in groups of at least two stacks,
b) separating said stacks from one another with a release sheet comprising a cellulosic-based paper substrate, wherein the improvement comprises the salt-treatment of at least one surface of said substrate during formation of the substrate via the application to said surface of an aqueous solution comprising at least one water-soluble multivalent salt in an amount sufficient to provide a solids content of about 0.01% to about 3.0% by weight based upon the dry weight of the substrate, and wherein said substrate is coated after formation on at least one salt-treated surface with a film comprising at least one salt of alginic acid,
c) consolidating said stacks of core sheets and said release sheet by the application of heat and pressure thereto, and
d) separating the resulting laminates from one another at the locus of said release sheet.

2. The method of claim 1 wherein the aqueous solution of water-soluble multivalent salt is applied during formation of the substrate in an amount sufficient to provide a solids content of about 0.05% to about 1.0% by weight based upon the dry weight of the substrate.

3. The method of claim 1 wherein the aqueous solution of water-soluble multivalent salt is applied during formation of the substrate in an amount sufficient to provide a solids content of about 0.1% to about 0.5% by weight based upon the dry weight of the substrate.

4. The method of claim 1 wherein the water-soluble multivalent salt is selected from the group consisting of salts of aluminum, salts of barium, salts of beryllium, salts of calcium, salts of chromium, salts of copper, salts of iron, salts of magnesium, salts of strontium, salts of zinc, salts of zirconium, and combinations thereof.

5. The method of claim 4 wherein the water-soluble multivalent salt is selected from the group consisting of salts of aluminum, salts of calcium, salts of magnesium, salts of zirconium, and combinations thereof.

6. The method of claim 4 wherein the water-soluble salt is calcium propionate.

7. The method of claim 1 wherein the alginic acid salt is a member selected from the group consisting of ammonium alginate, iron alginate, lithium alginate, potassium alginate, sodium alginate, and combinations thereof.
